(19) United States
(12) Patent Application Publication
(10) Pub. No.: US 2009/0078378 A1
(43) Pub. Date: Mar. 26, 2009

(54) PRIVACY BLIND

(76) Inventors: Dag H. Cecchetti, Madison, WI (US); Frank Klenko, Middleton, WI (US); Jody L. Reich, Spring Green, WI (US)

Correspondence Address: TAYLOR & AUST, P.C., P.O. Box 560, 142. S Main Street, Avilla, IN, 46710, US

(21) Appl. No.: 11/859,205

(22) Filed: Sep. 21, 2007

(51) Int. Cl. E06B 9/26

(52) U.S. Cl. 160/166.1; 160/236; 49/74.1

(57) ABSTRACT

A window blind for privacy includes slats made of transparent material having an embossed pattern and a printed pattern thereon sufficient to decrease the transparency of the slat and obscure visibility through the slats while maintaining a high degree of translucency. The lift cord is positioned outside of the slats, and the slats are constructed to close without exposing significant voids there through that are not overlapped by an adjacent slat. A valance is formed from slats and overlaps spaces that may occur above and below the head rail.

### BACKGROUND OF THE INVENTION

1. Field of the Invention

The present invention pertains generally to blinds for windows, doors and the like; and, more specifically, the invention pertains to blinds providing privacy during both day and night without blocking light passing through the blind.

2. Description of the Related Art

Coverings for windows, doors and other architectural openings serve a variety of purposes, both functional and aesthetic. Architects and consumers have placed increased emphases on the use of natural lighting in both workspaces and relaxation areas. Increased exposure to natural light, particularly during winter months of shortened daylight duration is believed by many to improve the attitude and well-being of individuals. Decreased reliance on artificial lighting can reduce energy requirements for a building.

Simply providing additional windows to increase the amount of natural light entering a space is not always satisfactory. In urban settings, the external view through some or all of the windows may be undesirable. Even in suburban settings, building density can be high, with large houses placed relatively closely together on small property lots such that adjacent houses are literally in the shadows of each other. In these circumstances, aesthetically pleasing window coverings can enhance the appearance of a room by blocking the undesirable view outside the window. However, with known window coverings, completely blocking undesirable views through a window has been accomplished only by limiting significantly the light entering a room, thereby requiring dependence on artificial light sources.

While uncovered windows providing natural lighting is often desirable, the bright light entering can become excessive on some days and for certain circumstances. Light diffusion to provide softened light to a room can be advantageous. Continued exposure to direct sunlight can fade fabrics on furniture and rugs, and can alter the appearance of photosensitive floorings. Protection against the damaging effects from direct, bright sunlight and ultraviolet radiation is desirable.

With any window, whether large or small, privacy can be a concern in both daytime and nighttime hours. Balancing the desired features of allowing natural light to enter a room while also providing privacy in private areas such as bathrooms and bedrooms has been problematic, particularly at night when the outside is dark and the room is illuminated with interior lighting. To provide true privacy during both daylight and nighttime hours, known shades have been room darkening, made of highly opaque materials not allowing significant light to pass through. Accordingly, the benefits of natural lighting have not been available when a high degree of privacy is required.

### SUMMARY OF THE INVENTION

The present invention forms slats from transparent material that readily passes light therethrough, and modifies a surface of each slat to obscure visibility through the slat and thereby provide privacy even at night when the room is illuminated. Light transmission through the blind remains high even after treating to provide privacy.

In one aspect thereof, the present invention provides a method of making a slat for a blind for an architectural opening. The method includes steps of extruding a slat body from a clear, transparent material, by forming a continuous strip having substantially parallel longitudinal edges and a width between the edges; and modifying at least one surface of the body to decrease the transparency of and obscure visibility through the body while maintaining translucency.

In another aspect thereof, the present invention provides a window blind with a head rail and a plurality of elongated slats suspended from the head rail. The slats are bodies of transparent material having an embossed pattern on at least one surface thereof sufficient to decrease transparency through the slat and obscure visibility through the blind.

In a further aspect thereof, the present invention provides a window blind with a head rail; a plurality of ladders suspended from the head rail, each ladder including uprights and rungs between the uprights; and a plurality of slats supported on the rungs, each slat being of transparent material having an embossed pattern on a surface thereof to decrease the transparency of the slat. At least some of the ladder uprights have loops thereon. A bottom rail is disposed beneath the slats, and a lift cord extends from the head rail through the loops and is connected to the bottom rail.

In yet another aspect thereof, the present invention provides a window blind slat with an elongated body having edges along elongated sides thereof. The body is of substantially transparent material having an embossment including impressions of higher and lower formations substantially covering a surface of the body between the edges sufficient to reduce transparency of the slat and obscure visibility through the slat.

In still another aspect thereof, the present invention provides a method of making a slat for a blind for an architectural opening. The method has steps of forming a slat body from a clear, transparent material; and embossing at least one surface of the body to decrease the transparency of the slat and obscure visibility through the slat while maintaining light transmission there through.

An advantage of the present invention, in one form thereof, is providing a blind for windows, doors and other architectural openings that distorts visibility to provide privacy, yet allows the transmission of light therethrough to provide natural lighting in the room, without substantial room darkening.

Another advantage of the present invention, in another form thereof, is providing a privacy blind that can be manufactured in a variety of different patterns and colors in a cost effective, economic manner.

Still another advantage of the present invention, in still another form thereof, is providing a method to manufacture slats for blinds that provide privacy yet allow light transference.

A further advantage of the present invention, in a further form thereof, is providing a window blind with structure enabling substantially complete covering of an opening, without significant holes, voids or spaces that can provide an unaesthetic appearance.

A still further advantage of the present invention, in a still further form thereof, is providing a window blind with a bottom rail and a head rail valance that blend in appearance with the slats of the blind.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of a privacy blind in accordance with the present invention installed on patio doors, with the blind shown in an open condition;

FIG. 2 is a perspective view similar to that of FIG. 1, but illustrating the blind in a closed condition;

FIG. 3 is an enlarged fragmentary perspective view of several slats of the blind shown in FIGS. 1 and 2, the view shown from the tops of the slats;

FIG. 4 is an enlarged, fragmentary perspective view similar to that of FIG. 3 but from an angle to better show the bottoms of the slats;

FIG. 5 is an enlarged, fragmentary perspective view similar to that of FIG. 3, but illustrating the blind in a closed condition;

FIG. 6 is an enlarged fragmentary view of the bottom rail for the blind shown in the preceding views;

FIG. 7 is a fragmentary vertical cross-sectional view of one of the ladder portions of the blind shown in the preceding drawings;

FIG. 8 is a fragmentary cross-sectional view of the blind shown in FIG. 7, the view taken on line 8-8 of FIG. 7;

FIG. 9 is a fragmentary cross-sectional view of the blind shown in FIG. 7, the view taken along line 9-9 of FIG. 7;

FIG. 10 is a flow diagram of a process for manufacturing blind slats in accordance with the present invention;

FIG. 11 is a perspective view of a laminating roll used in the process shown in FIG. 10;

FIG. 12 is a perspective view of an embosser used in the process shown in FIG. 10;

FIG. 13 is a perspective view of a shaping fixture used in the process shown in FIG. 10; and

FIG. 14 is a cross-sectional view through a head rail and valance of a blind of the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

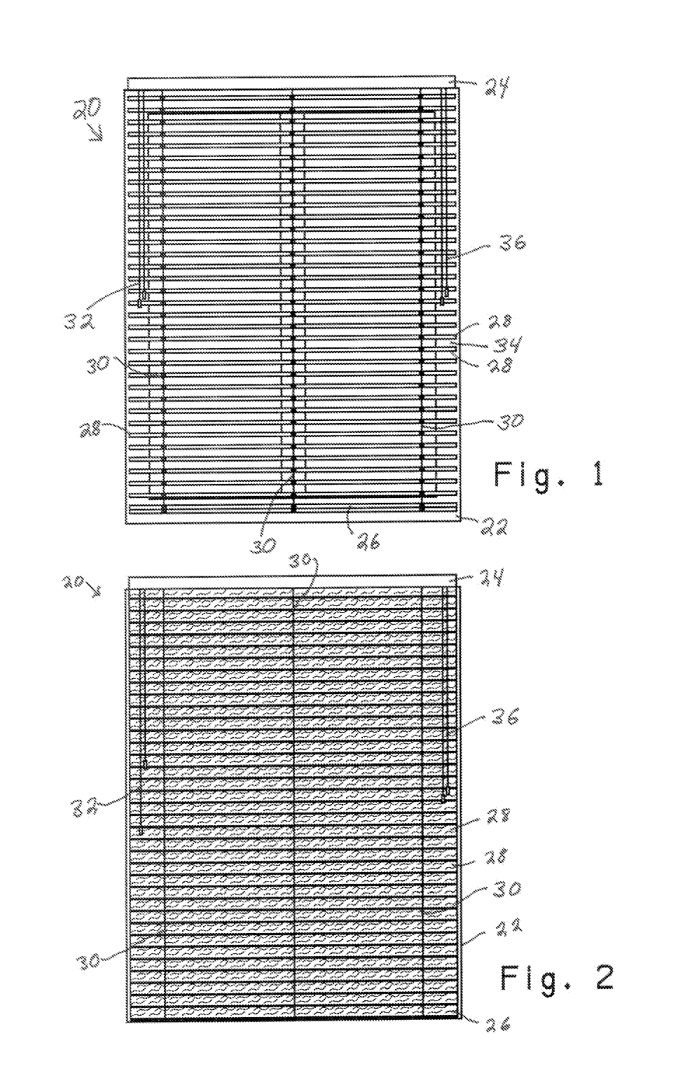

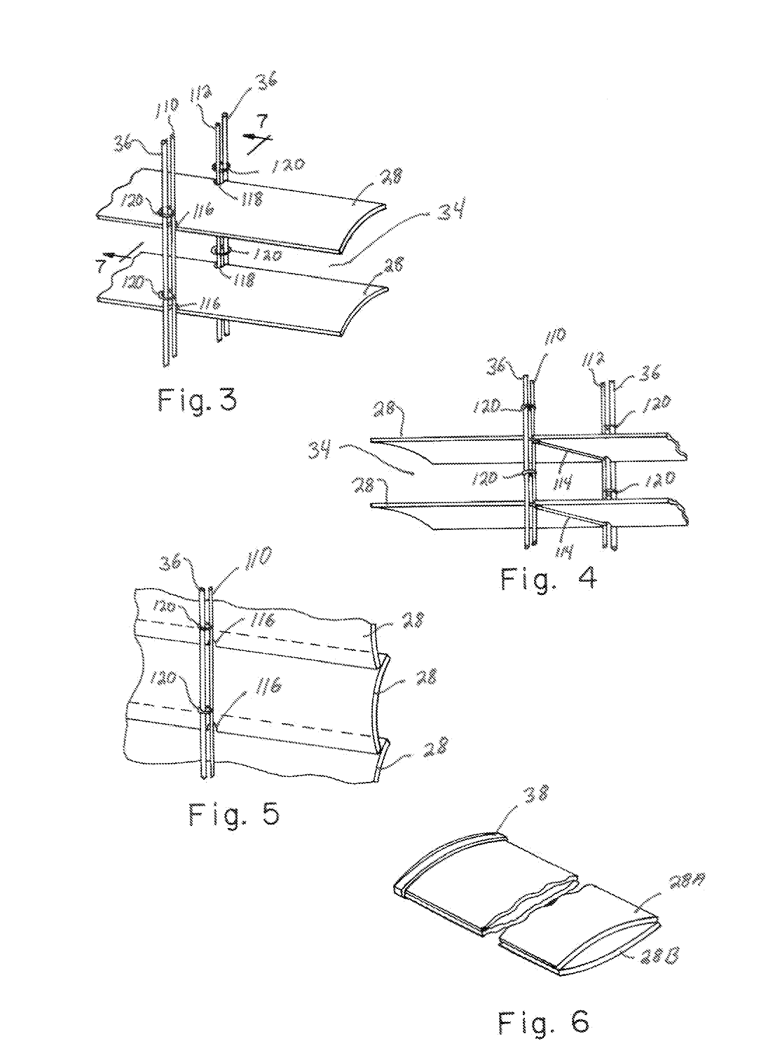

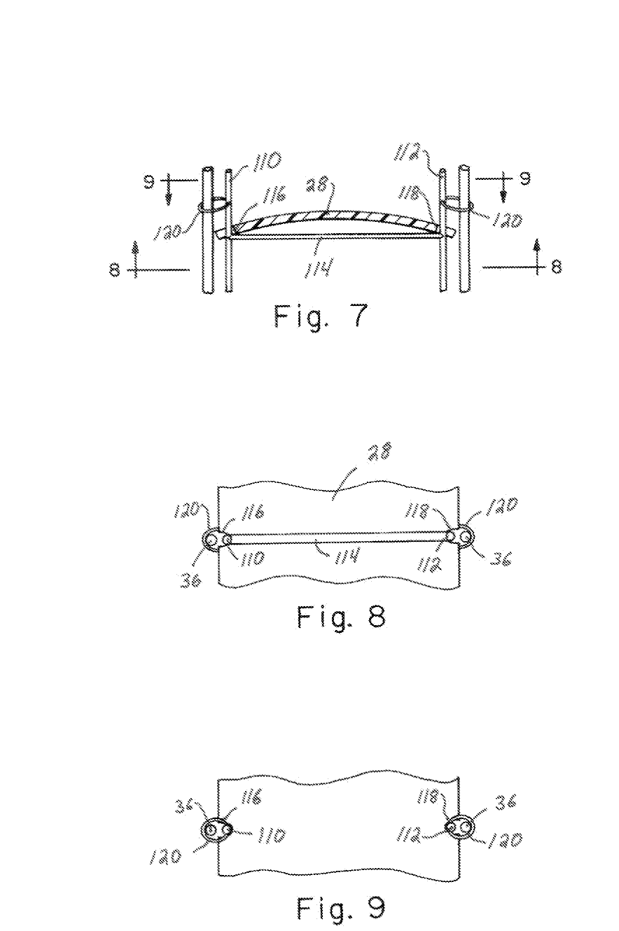

Referring now to the drawings more specifically, and to FIGS. 1 and 2 thereof in particular, a privacy blind 20 in accordance with the present invention is shown installed on a patio door assembly 22. A privacy blind 20 in accordance with the present invention can be used advantageously on architectural openings of many types including windows, doors and the like, and is particularly advantageous in conditions where privacy is desired or required in combination with the transmission of light through the blind to provide natural lighting in the room.

Privacy blind 20 includes a head rail 24, a bottom rail 26 and a plurality of slats 28 therebetween. In FIGS. 1 and 2, only some of the slats 28, but not all of the slats 28 are indicated with reference numbers. Slats 28 are suspended on ladders 30, as will be described more fully hereinafter. For more narrow blinds 20, two ladders 30 may be sufficient; and on wider blinds 20 three, four or more ladders 30 may be used. In the exemplary embodiment, three ladders 30 are provided. Also shown in FIGS. 1 and 2 are ladder operator cords 32 for operating the ladders in known manner to tilt slats 28 between substantially horizontal positions as shown in FIG. 1, commonly referred to as an “open” condition, in which spaces 34 are provided between adjacent, substantially horizontal slats 28; and a “closed” condition as shown in FIG. 2 in which the slats 28 are tilted to close spaces 34 with the individual slats substantially vertically positioned on edge. Ladders 30 can be adjusted to place slats 28 at intermediate positions between the fully open and full closed positions shown in FIGS. 1 and 2, respectively.

Lift cords 36 are also shown in FIGS. 1 and 2 for raising and lowering bottom rail 26, causing slats 28 to stack thereon from the bottom up as is well known to those skilled in the art. Lift cords 36 have distal ends as indicated in FIGS. 1 and 2, and extend coextensively with ladders 30 from head rail 24 to bottom rail 26, as will be described more fully hereinafter.

Head rail 24 is mounted to patio door assembly 22, with ladders 30 having slats 28 installed therein suspended from head rail 24 in known manner. Head rail 24 includes various operating mechanisms for tilting ladders 30, guides for routing lift cords 36 to raise and lower bottom rail 26, necessary cord locks for securing adjusted positions of the blind and the like. Various such mechanisms for head rail 24 can be used, and are well known to those skilled in the art. The particular types of operating mechanisms in head rail 24 are not relevant to the present invention and therefore will not be described in further detail herein.

Bottom rail 26 in known blinds is a thin bar or tube forming the bottom of the blind and upon which the slats 28 stack as the blind is raised. In known designs, the bottom rail thereby forms an outline or demarcation at the bottom of the blind that appears differently from the slats there above. In accordance with the present invention, bottom rail 26 is formed of two slats 28, designated as 28A and 28B in FIG. 6. Slats 28A and 28B are oppositely directed, that is they face in opposite directions to form an elliptical shape in cross-section. By using two slats 28A and 28B to form bottom rail 26, the appearance of blind 20 beneath head rail 24 is consistent all the way through to the bottom edge of the blind. Slats 28A and 28B can be fastened one to another by end caps 38 at each end (one end cap 38 being shown in FIG. 6), adhesive or other means. An advantage of using end caps 38 is providing a finished look and closing the end openings between slats 28A and 28B.

As thus far described, exemplary blind 20 is a so-called “horizontal blind” with slats 28 horizontally disposed beneath head rail 24, and a plurality of slats 28 arranged one beneath another between head rail 24 and bottom rail 26. However, it should be understood that slats 28 of the present invention can be used also for so-called “vertical blinds” in which the slats are suspended vertically from one end beneath head rail 24, with each slat extending from the head rail to the bottom of the blind, and a plurality of the slats arranged one beside another across the width of the blind. Commonly, in a vertical blind a bottom rail is not provided, and lift cords are not required.

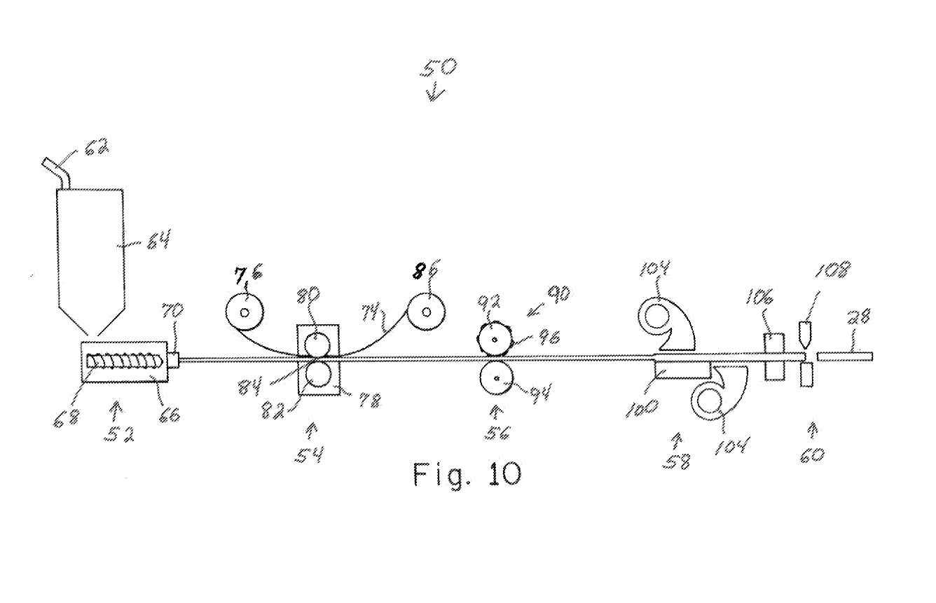

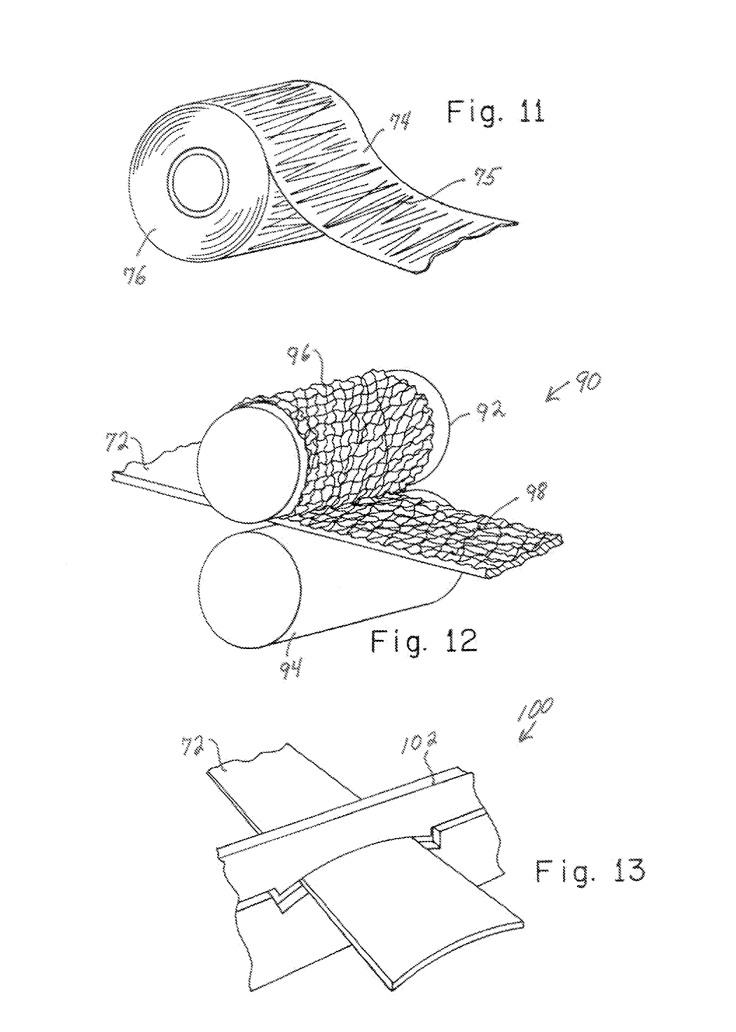

Slats 28 of the present invention are made of material and formed by a process whereby light is transmitted readily through each slat, but the translucency of the slat is increased to provide privacy. An exemplary process 50 for making slats 28 is shown in FIG. 10. Suitable materials for slats 28 include transparent or translucent plastics such as, but not limited to acrylics, clear PVC, polycarbonates and butyrate.

Process 50 of the present invention includes a forming step 52, a printing step 54, an embossing step 56, a shaping step 58 and a sizing or cutting step 60. It should be understood that process 50 to be described hereinafter is exemplary for use with acrylics, and the details of the various process steps may vary depending on the material being used to form slats 28.

In forming step 52, if the material being used is hydroscopic, a supply 62 of the material, normally pellets or other discrete particles of acrylic resin, for example, is treated preliminarily by pre-drying to remove moisture and prevent the formation of bubbles in the subsequent forming steps. Again, for the exemplary use of acrylic pellets, drying for approximately two and one-half hours at 175° F. has been found suitable for removing excess moisture. The pre-dried acrylic resin is vacuum loaded into a hopper 64. From hopper 64, the acrylic resin is gravity-fed to an extruder 66, which in the exemplary embodiment is a screw extruder having a screw 68 therein. Screw 68 is suitable for use with acrylics and includes flights thereon decreasing in depth from the inlet end to the outlet end of extruder 66. As known to those familiar with the extrusion art, as the acrylic material is conveyed forward by screw 68, with the depth of the flight on screw 68 decreasing, the material is compressed increasingly. The increased compression generates shear heat in the material. The shear heat along with supplemental heat from external barrel heaters breaks down the acrylic pellets into a low viscosity melt. Temperatures should be kept sufficiently high to form a clear extrusion. Generally, higher temperatures provide clearer acrylic extrusions, and a melt temperature of approximately 420° F. has been found to be adequate for desired levels of clarity. A die 70 is provided at the front of extruder 66, and the melted acrylic is forced through die 70 as the material emerges from extruder 66. The emerging material forms a continuous web or strip 72 having the general shape of die 70, again has well understood by those familiar with the art. Standard slat sizes can be formed in thicknesses from approximately 0.038 inch to approximately 0.150 inch and in widths between the edges of strip 72 from approximately 1.5 inch to approximately 3.7 inches.

Strip 72 advances from extruder 66 to printing step 54 wherein option patterns, designs and colors can be applied to a surface of the strip. It should be understood that between extruder 66 and printing step 54, strip 72 may require support by use of air jets, rollers or the like.

Printing step 54, in the exemplary process shown, is a laminating or transfer printing process in which ink in a desired pattern, which can be specifically designed or random, is transferred to a surface of strip 72. In a suitable transfer process, a Mylar or other web 74 (FIG. 11), having an ink pattern 75 thereon, is provided as a supply roll 76 from which a continuous feed thereof passes through an ink-transfer station or laminator 78 including opposed rollers 80, 82 forming a transfer nip 84. The term “ink” as used herein is intended to include inks and paints of various types as well as pigmented solids or other colorants that can be applied to strip 72. Acrylic strip 72 and Mylar web 74 pass together through nip 84, wherein the ink pattern 75 on web 74 is released from web 74 and transferred to the surface of strip 72 under the application of pressure in nip 84. After the ink is released there from, web 74 is accumulated on a take-up roll 86.

Printing step 54 is performed relatively close to extruder 66, but spaced sufficiently therefrom so that some cooling of strip 72 occurs before strip 72 enters laminator 78. If strip 72 is too hot, Mylar web 74 can wrinkle or melt. However, laminator 78 should not be so far from extruder 66 that strip 72 is cooled excessively. Strip 72 should remain sufficiently hot that proper ink transfer occurs from Mylar web 74 to extruded strip 72. Generally, if strip 72 at the exit from transfer nip 84 maintains an exit temperature at about 300° F. sufficient ink transfer occurs without wrinkling in Mylar web 74.

Printing step 54 can be performed using ink pattern 75 provided on web 74 in specific designed patterns of objects or things such as flowers, leaves or the like. Further, ink pattern 75 for printing step 54 can be provided in desired geometric or random patterns. Further, ink pattern 75 can be provided in discrete lines or shapes or can be provided as a continuous colored band or block for full color coverage of the entire surface of strip 72, or of discrete portions thereof such as bands or stripes. Single solid colors or multi-colors can be used as ink pattern 75. Artistic and aesthetic concerns can be met by virtually limitless printing configurations. However, it should be understood that printing step 54 also can be omitted, and a clear unprinted strip 72 can be passed to subsequent processing. While a laminating or transfer process is shown in the exemplary process 50, other coloring or printing processes also can be used, such as, for example and not limitation, wash coat, gravure or tip printing. Further, instead of or in addition to printing step 54, color can be added to strip 72 during the extrusion or other forming process by the addition of colorants to the feed material.

From printing step 54, the printed strip 72 advances to embossing step 56 wherein physical modifications are made to a surface of strip 72 that decrease the transparency of strip 72 while retaining a high level of translucency. An embosser 90 includes an embossing wheel 92 and a backing wheel 94. Embossing wheel 92 has surface configurations 96 in the form of discrete projections to create a surface topography or embossment of impressions 98 (FIG. 12) on strip 72. Impressions 98 are formed of sufficiently varying height and depth, and sufficiently close to one another so as to reduce the transparency of strip 72 while retaining a desired level of translucency to provide desired privacy features regarding visibility through the slat together with a desired level of light transfer through the slat. Decreased transparency, making the strip translucent, is achieved with deeper impressions more closely spaced together. For greater privacy, the embossment should substantially cover the entire surface between edges of strip 72. The temperature of strip 72 in embosser 90 should remain sufficiently high for suitable penetration depth in the embossing step 56, and for subsequent handling to be described. However, the temperature of strip 72 at embossing step 56 should not be so high as to cause material flow after embossing, which can distort the embossing pattern and degrade embossing detail. It has been found that an exit temperature for strip 72 as the strip emerges from embosser 90 of about 250° F. works well together with a nip pressure of about 1000 psi between embossing wheel 92 and backing wheel 94. Various patterns can be used in embossing step 56 to provide desired aesthetic effects as well as performance.

From embossing step 56, web 72 advances to shaping step 58 wherein both cooling and shaping occurs. A shaping table 100 provides a crown across the width of the slat, from one side edge to the other side edge. A crown of approximately ¼ inch has been found satisfactory. Crowning plates 102 (FIG. 13), as known to those skilled in the art, can be used above and below strip 72. Crowning improves rigidity of the slat, and may be desirable for longer slats; however, flat slats without crowning also can be used. Maintaining a temperature of approximately 250° F. at the exit of the embosser not only improves embossing but also ensures sufficient flexibility in an acrylic strip 72 for shaping.

Fans 104 provided above and/or below strip 72 force air against and around the strip from opposite sides to promote cooling. Relatively slow, even cooling is preferred to prevent warping or curling. While two fans 104 are shown, it should be understood that a series of fans 104, both above and below strip 72, can be used.

Upon completion of final shaping and cooling, strip 72 is passed through a puller 106 to cutting step 60 wherein desired lengths for slats 28 are cut. Cutting step 60 can include operating a saw, knife or other cutting means 108 for severing strip 72 in desired lengths for subsequent use. Various types of encoders and other measuring or length determining systems and processes can be used to ensure consistent desired lengths for all slats 28 emerging from cutting station 60.

As understood by those familiar with extrusion processes, puller 106 near the end of process 50 is used to move strip 72 through out the process. Pullers well known in the industry include belt pullers and other types that can be used in the present process. Desirably, puller 106 will not mark or otherwise disfigure the completed product. As those skilled in the art of extrusion processes will readily understand, puller 106, embosser 90 and laminator 78 are synchronized to the same speeds to maintain constant tension in strip 72.

Formed in this manner, slats 28 are translucent and light diffusing from the embossment formed therein. The transparency thereof is decreased to provide privacy by obscuring visibility through the slat, but the slat remains translucent to allow light to pass there through.

Ladders 30 have a pair of uprights 110, 112 and a series of rungs or cross-members 114 extending therebetween. Slats 28 are supported on rungs 114. Differential vertical movement between uprights 110, 112 causes rungs 114 to assume different angular positions, from substantially horizontal as required for the open position of blind 20 as shown in FIG. 1, to the severely angular, almost vertical position in which the slats are nearly vertical on edge as shown in FIG. 2. Since slats 28 are supported on rungs 114, slats 28 move together with rungs 114 as the rungs are moved between various angular positions.

To retain proper lengthwise positioning of slats 28 within ladders 30, notches 116, 118 are provided on the front and back edges of slats 28 respectively, to receive therein the uprights 110, 112. It should be understood that while notches on the front and back are shown, notches on only one or the other edge also can be used, perhaps alternating with notches for others of the ladders 30 when multiple ladders are used.

At spaced positions along the lengths thereof, ladder uprights 110, 112 are provided with loops 120 positioned outwardly. Lift cords 36 extend through loops 120 from head rail 24 to bottom rail 26. Lift cords 36 can be provided on the front and back of each ladder 30 or can be provided on one or the other. When multiple ladders and lift cords are used, each ladder can include two lift cords as shown in FIG. 3, or one ladder can have a lift cord 36 on the front edge thereof and another ladder 30 can have a lift cord 36 at the back edge thereof. Further, with multiple ladders, each ladder can be provided with one or two lift cords as described, or some ladders can be used without lift cords when sufficient lift cords are provided on others of the ladders. By providing the lift cords away from the slats 28, slats 28 are continuous without interruption except for the shallow notches 116, 118, and when Blind 20 is closed as shown in FIG. 5 no holes or openings extend through one slat that are not covered by an overlapping slat. As shown in FIG. 5, notches 116 are covered by the slat there behind, so that no unobstructed light passes therethrough.

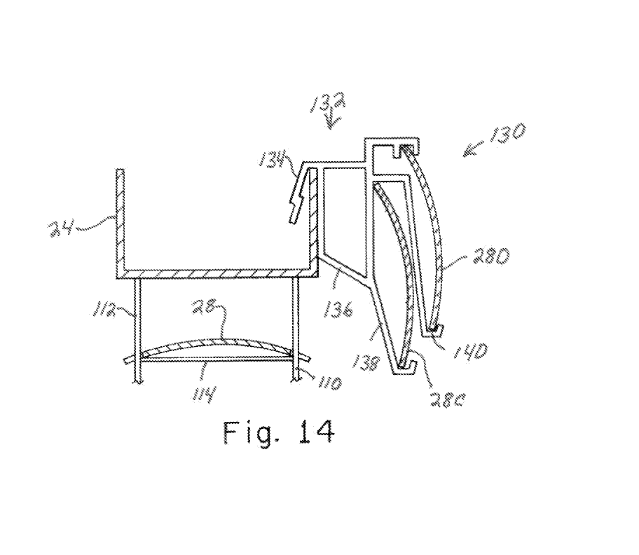

FIG. 14 shows a valence 130 for head rail 24. A plurality of head rail clips 132 are used connected to head rail 24. Only one head rail clip 132 is visible in the cross-section shown in FIG. 14; however, it should be understood that two or more clips 132 will be used. Each clip 132 includes a spring arm of 134 for connecting to head rail 24, a body portion 136 projecting in front of head rail 24 and first and second holding arms 138, 140 to hold first and second overlapping slats 28C and 28D. Slats 28C and 28D are similar to slats 28, 28A and 28B. Accordingly, valance 130 provides a consistent color and appearance as in the main portion of blind 20. Further, uppermost most slat 28D overlaps and covers any space at the top of head rail 24, and lower slat 28C overlaps and covers any space between the bottom of head rail 24 and the uppermost slat 28 in blind 20.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of making a slat for a blind for an architectural opening, said method comprising the steps of:
extruding a slat body from a clear, transparent material, including forming a continuous strip having substantially parallel longitudinal edges and a width between the edges;
modifying at least one surface of said body to decrease the transparency of and obscure visibility through said body while maintaining translucency.

2. The method of claim 1, including embossing said at least one surface of said body.

3. The method of claim 1, including applying ink to said at least one surface of said body.

4. The method of claim 1, including applying ink to said at least one surface of said body and thereafter embossing said body.

5. The method of claim 1, including applying ink and embossing a same surface of said body.

6. The method of claim 5, including crowning the slat across the width thereof.

7. The method of claim 5, including cutting the slat to a desired length from a continuous strip of an extruded slat body, said cutting performed after said steps of embossing and applying ink.

8. The method of claim 7, including crowning the slat across the width thereof between said edges.

9. A window blind comprising:
a head rail;
a plurality of elongated slats suspended from said head rail; and
said slats being bodies of transparent material having an embossed pattern on at least one surface thereof sufficient to decrease transparency through the slat and obscure visibility through the blind.

10. The window blind of claim 9, said slats having a printed pattern on at least one surface thereof.

11. The window blind of claim 10, said embossed pattern and said printed pattern provided on the same surface.

12. The window blind of claim 9, including a valance along the front of said head rail, said valance including clips attached to said head rail and overlapping slats held in said clips.

13. The window blind of claim 9, said slats being crowned across the width thereof.

14. A window blind comprising:
a head rail;
a plurality of ladders suspended from said head rail, each said ladder including uprights and rungs between said uprights;
a plurality of slats supported on said rungs, each said slat being of transparent material having an embossed pattern on a surface thereof to decrease the transparency of the slat;
at least some of said ladder uprights having loops thereon;
a bottom rail disposed beneath said slats; and
a lift cord extending from said head rail through said loops and connected to said bottom rail.

15. The window blind of claim 14, said slats defining notches in elongated edges thereof, and said uprights generally positioned in said notches.

16. The window blind of claim 14, said bottom rail comprising a pair of slats.

17. The window blind of claim 14, said slats having a colored pattern on a surface thereof.

18. The window blind of claim 14, said material being acrylic.

19. The window blind of claim 14, said slats being crowned across a width thereof.

20. A window blind slat comprising:
an elongated body having edges along elongated sides thereof;
said body being of substantially transparent material; and
said body having an embossment of impressions of higher and lower formations, said embossment of impressions substantially covering a surface of said body between said edges and being sufficient to reduce transparency of the slat and obscure visibility through said slat.

21. The slat of claim 20 having a printed surface between said edges with a colored printing thereon.

22. The slat of claim 21, said embossed surface and said printed surface being the same surface.

23. The slat of claim 20, said body being crowned between said edges.

24. A method of making a slat for a blind for an architectural opening, said method comprising the steps of:
forming a slat body from a clear, transparent material; and
embossing at least one surface of said body to decrease the transparency of the slat and obscure visibility through the slat while maintaining light transmission there through.

25. The method of claim 24 including applying a colored pattern to said body.
